(19) United States
(12) Patent Application Publication
(10) Pub. No.: US 2014/0067387 A1
(43) Pub. Date: Mar. 6, 2014

(54) Utilizing Scalar Operations for Recognizing Utterances During Automatic Speech Recognition in Noisy Environments

(71) Applicants: Jinyu Li, Redmond, WA (US); Michael Lewis Seltzer, Seattle, WA (US); Yifan Gong, Sammamish, WA (US)

(72) Inventors: Jinyu Li, Redmond, WA (US); Michael Lewis Seltzer, Seattle, WA (US); Yifan Gong, Sammamish, WA (US)

(73) Assignee: MICROSOFT CORPORATION, Redmond, WA (US)

(21) Appl. No.: 13/603,796

(22) Filed: Sep. 5, 2012

(51) Int. Cl. G10L 15/20

(52) U.S. Cl. 704/233; 704/E15.039

(57) ABSTRACT

Scalar operations for model adaptation or feature enhancement may be utilized for recognizing an utterance during automatic speech recognition in a noisy environment. An utterance including distorted speech generated from a transmission source for delivery to a receiver, may be received by a computer. The distorted speech may be caused by the noisy environment and channel distortion. Computations using scalar operations in the form of an algorithm may then be performed for recognizing the utterance. As a result of performing all of the computations with scalar operations, computational complexity is very small in comparison to matrix and vector operations. Vector Taylor Series with diagonal Jacobian approximation may also be utilized as a distortion-model-based noise robust algorithm with scalar operations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many computer software applications utilize speech recognizers for performing automatic speech recognition (“ASR”) in association with various voice-activated functions. These voice-activated functions, which may include the processing of information queries, may be initiated from any number of devices such as desktop and laptop computers, tablets, smartphones, and automotive computer systems. However, the performance of ASR is degraded in the presence of additive noise which is often encountered in real-world scenarios. For example, additive noise caused by engine and road noise when traveling in an automobile, by patrons in a restaurant or by speakers on a crowded street, may interfere with or distort user commands spoken into a microphone during ASR. In particular, the additive noise degrades the accuracy of ASR due to the mismatch between the typically noise-free speech used to train the speech recognizer and noisy speech which may be encountered during use. Previous approaches for addressing ASR performance degradation have been directed to adapting (i.e., updating) the statistical parameters of the recognizer to more accurately reflect the conditions (i.e., environmental noise) which may be encountered during use. However, these previous approaches are associated with high computational costs, such as thousands of complex matrix and vector operations, which prevents them from being adopted for widespread use. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for utilizing scalar operations to facilitate the recognition of an utterance during automatic speech recognition in a noisy environment. The utterance may include distorted speech, caused by channel distortion and the noisy environment, which is generated from a transmission source for delivery to a receiver. Computations using scalar operations in the form of an algorithm may then be performed for recognizing the utterance.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for utilizing scalar operations for recognizing an utterance during automatic speech recognition in a noisy environment, in accordance with various embodiments;

FIG. 2 is a block diagram illustrating various environmental distortion model parameters which may be utilized in scalar operations for recognizing an utterance during automatic speech recognition in a noisy environment, in accordance with various embodiments

FIG. 3 is a block diagram illustrating various speech model parameters, in accordance with various embodiments;

FIG. 4 is a flow diagram illustrating a routine for utilizing scalar operations for recognizing an utterance during automatic speech recognition in a noisy environment, in accordance with various embodiments;

FIG. 5 is a flow diagram illustrating a routine for utilizing a speech adaptation model utilizing scalar operations for recognizing an utterance during automatic speech recognition in a noisy environment, in accordance with various embodiments;

FIG. 6 is a flow diagram illustrating a routine for utilizing a speech feature enhancement model utilizing scalar operations for recognizing an utterance during automatic speech recognition in a noisy environment, in accordance with various embodiments;

FIG. 7 is a simplified block diagram of a computing device with which various embodiments may be practiced;

FIG. 8A is a simplified block diagram of a mobile computing device with which various embodiments may be practiced;

FIG. 8B is a simplified block diagram of a mobile computing device with which various embodiments may be practiced; and

FIG. 9 is a simplified block diagram of a distributed computing system in which various embodiments may be practiced.

### DETAILED DESCRIPTION

Embodiments are provided for utilizing scalar operations to facilitate the recognition of an utterance during automatic speech recognition in a noisy environment. The utterance may include distorted speech, caused by channel distortion and the noisy environment, which is generated from a transmission source for delivery to a receiver. Computations using scalar operations in the form of an algorithm may then be performed for recognizing the utterance.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

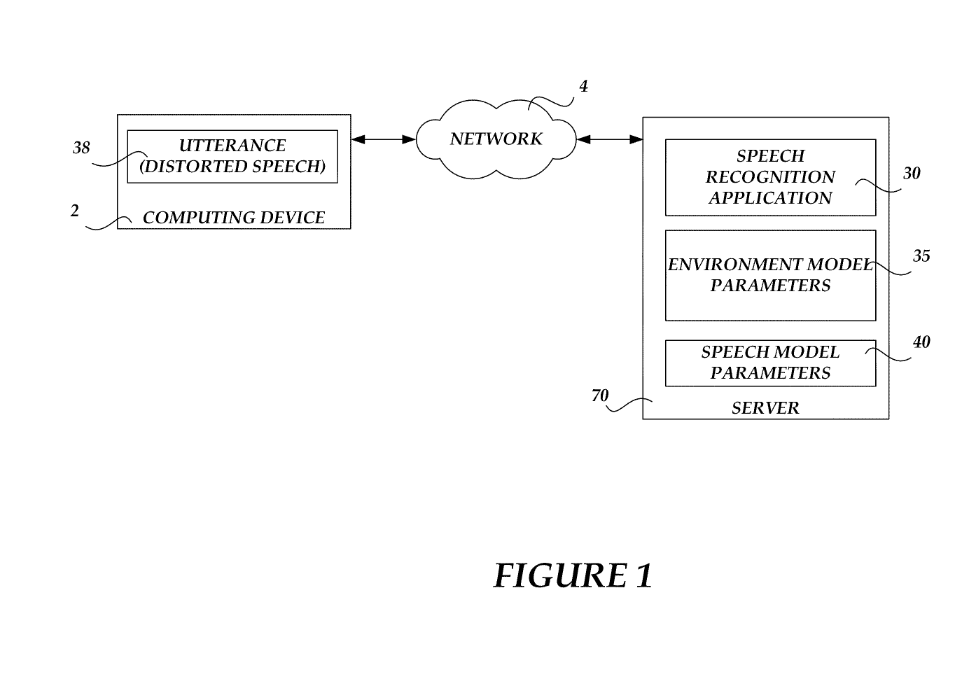

Referring now to the drawings, in which like numerals represent like elements through the several figures, various aspects of the present invention will be described. FIG. 1 is a block diagram illustrating a network architecture for utilizing scalar operations for recognizing an utterance during automatic speech recognition in a noisy environment, in accordance with various embodiments. The network architecture includes a computing device 2 in communication with a server 70 over a network 4. The server 70 may include a speech recognition application 30, environmental distortion model parameters 35 and speech model parameters 40. The computing device 2 may include an utterance 38. In accordance with various embodiments, the computing device 2 may comprise a computer capable of executing one or more application programs including, but not limited to, a desktop computer, a laptop computer, a tablet computer, a “smartphone” (i.e., a mobile phone having computer functionality and/or which is capable of running operating system software to provide a standardized interface and platform for application developers), and an automobile-based computer.

The speech recognition application 30 in the server 70 may comprise a software application which utilizes automatic speech recognition (“ASR”) to perform a number of functions which may include, but are not limited to, search engine functionality (e.g., business search, stock quote search, sports scores, movie times, weather data, horoscopes, document search), navigation, voice activated dialing (“VAD”), automobile-based functions (e.g., navigation, turning a radio on or off, activating a cruise control function, temperature control, controlling video display functions, and music and video playback), device control functions (e.g., turning the computing device 2 off, recording note, deleting/creating/moving files), and messaging (e.g., text and MMS), media (e.g., taking a picture). In accordance with an embodiment, the speech recognition application 30 may comprise the BING online services web search engine from MICROSOFT CORPORATION of Redmond, Wash. It should be appreciated, however, that other speech recognition application programs from other manufacturers may be utilized in accordance with the various embodiments described herein.

In accordance with an embodiment and as will be described in greater detail below, the speech recognition application 30 in the server 70 may be configured to execute an algorithm which utilizes scalar operations for recognizing an utterance during ASR in a noisy environment. As defined herein, “scalar” operations refer to operations involving mathematical functions which utilize only single numbers (i.e., a sequence of independent numbers) for performing computations involving the environmental distortion model parameters 35 to recognize an utterance during ASR in a noisy environment. It should be appreciated that scalar operations differ from matrix operations in that vectors representing speech parameters which are utilized in ASR computations do not have to be treated as a coherent entity. That is, unlike other methods for recognizing speech in a noisy environment, the vectors do not need to be multiplied by large matrices (e.g., a 39 by 39 matrix) which, due to their complexity carry extremely high computational costs. Instead, scalar operations facilitate the treatment of vectors as independent numbers thereby allowing each of a number of components comprising a vector to be multiplied by a single number (instead of by a matrix). In accordance with various embodiments, the speech recognition application 30 may comprise an algorithm which may include either a Hidden Markov Model (“HMM”) or a Gaussian Mixture Model (“GMM”). As should be understood by those skilled in the art, an HMM is a statistical hidden Markov model in which the system being modeled is assumed to be a Markov process with unobserved (hidden) states. An HMM can be considered as the simplest dynamic Bayesian network. HMMs may be utilized in speech recognition systems to help to determine the words represented by the sound waveforms captured from an utterance. As should be understood by those skilled in the art, a GMM is a parametric probability density function represented as a weighted sum of Gaussian component densities. GMMs may be utilized in speech recognition systems.

As will be described in detail below, the algorithm executed by the speech recognition application 30 may utilize the environmental distortion model parameters 35 which may include HMM parameters (for model adaptation) and GMM parameters (for feature enhancement). In accordance with various embodiments, model adaptation may be utilized in the decoding of an utterance (i.e., speech) so that it may be understood in a noisy environment while feature enhancement may be utilized to enhance certain speech features (e.g., to estimate a clean speech from noisy speech) so that an utterance may be better understood in a noisy environment. In accordance with other embodiments, a Vector Taylor Series (“VTS”) with diagonal Jacobian approximation algorithm may be utilized by the speech recognition application 30. The use of a VTS with diagonal Jacobian approximation algorithm by the speech recognition application 30 will be discussed in greater detail below.

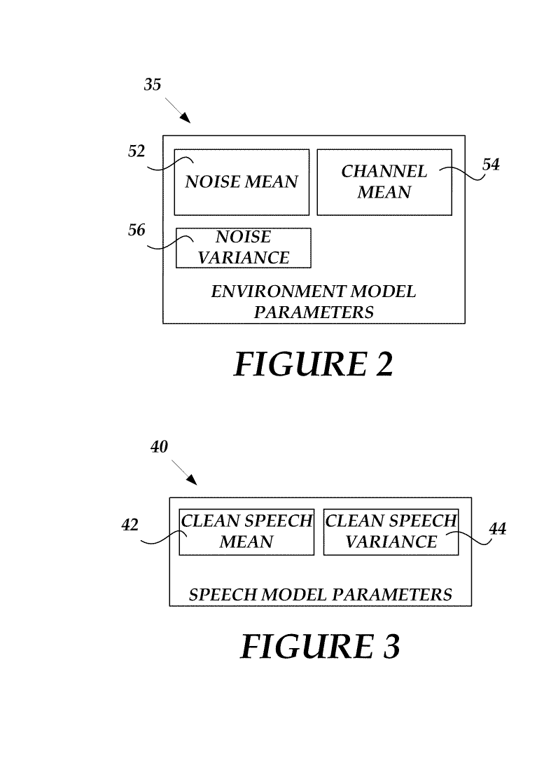

In accordance with an embodiment, the utterance 38 may comprise distorted speech generated from a transmission source for delivery to a receiver in a noisy environment. For example, a user of the computing device 2 may use a microphone to initiate a search query for navigation instructions from the computing device 2 (i.e., the transmission source) for delivery to the server 70 (i.e., the receiver) over the network 4 while walking on a crowded street. In accordance with an embodiment, the speech model parameters 40 may be utilized by the speech recognition application 30 to represent different aspects of the distorted speech contained within the utterance 38. The speech model parameters 40 will be described in greater detail below with respect to FIG. 2.

The computing device 2 may communicate with the server 70 over the network 4 which may include a local network or a wide area network (e.g., the Internet). In accordance with an embodiment, the server 70 may comprise one or more computing devices for receiving the utterance 38 from the computing device 2 and for sending an appropriate response thereto (e.g., the server 70 may be configured to send results data in response to a query received in an utterance from the computing device 2).

FIG. 2 is a block diagram illustrating various parameters in the environmental distortion model parameters 35 which may be utilized by the speech recognition application 30 in scalar operations for recognizing an utterance during automatic speech recognition in a noisy environment, in accordance with various embodiments. The environmental distortion model parameters 35 may include a noise mean parameter 50, a channel mean parameter 52 and a noise variance parameter 54. The noise mean parameter 50 and the channel mean parameter 52 represent static cepstral means of noise present in an utterance. The noise variance parameter 54 represents the static and dynamic variances of noise present in an utterance.

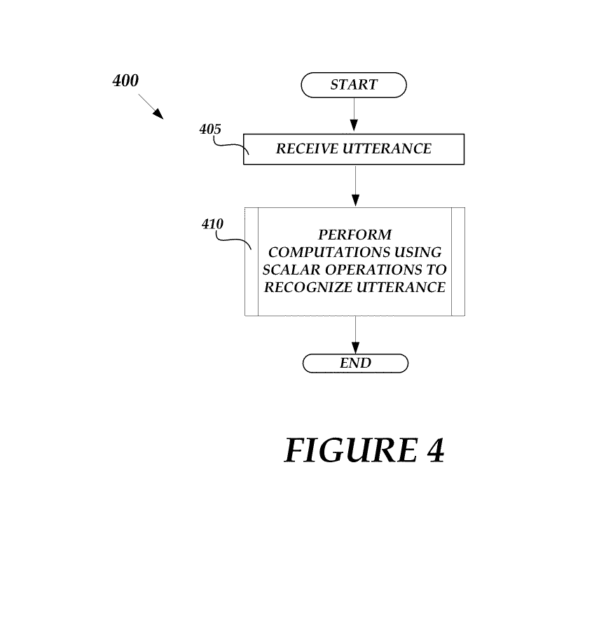

FIG. 3 is a block diagram illustrating various parameters in the speech model parameters 40, in accordance with various embodiments. The speech model parameters 40 may include a distorted speech parameter 42, a clean speech parameter 44, a noise parameter 46 and a channel parameter 48. As defined herein, the distorted speech parameter 42 represents the portion of the utterance 38 which includes noise and channel distortions present in the speech received by the server 70 from the computing device 2. The clean speech parameter 44 represents the utterance 38 without noise or channel distortions. The noise parameter 46 represents the portion of the utterance 38 which includes noise present in the environment of the speaker of the utterance 38 as the utterance 38 is being made by a speaker into the computing device 2 for delivery to the network server 70. The channel parameter 48 represents the speech transmission path of the utterance 38 between the speaker of the utterance 38 and a device used to capture the speech (e.g., a microphone) at the computing device 2. The channel parameter 48 may also represent the speech transmission path of the utterance 38 between the computing device 2 and the server 70.

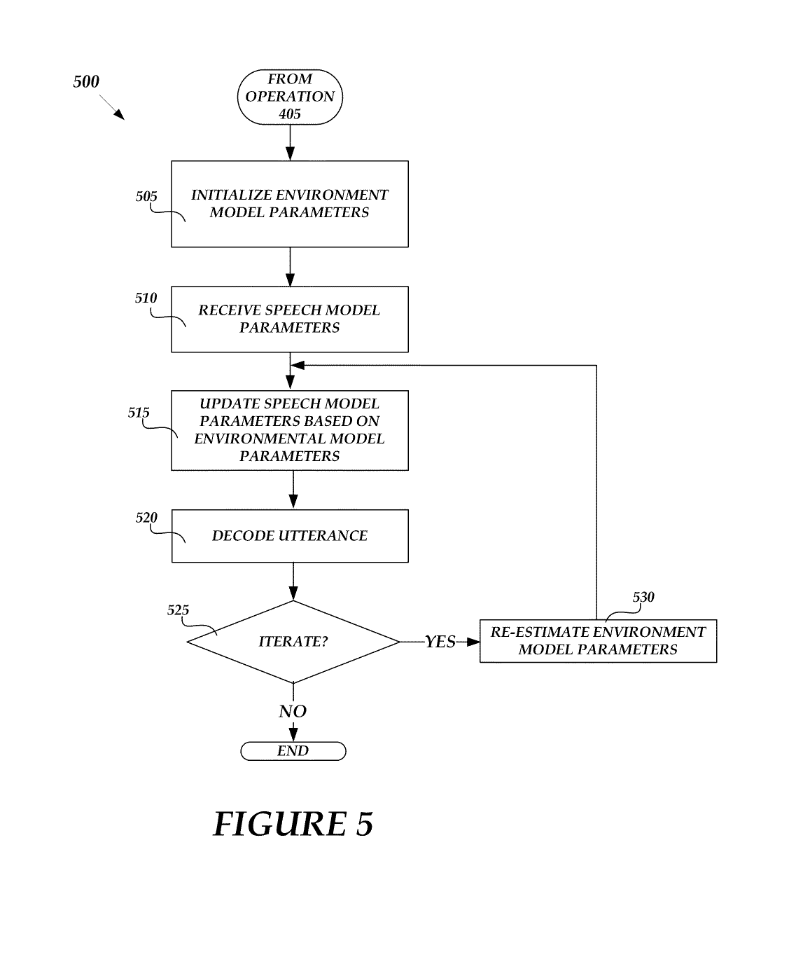

FIG. 4 is a flow diagram illustrating a routine 400 for utilizing scalar operations for recognizing an utterance during automatic speech recognition in a noisy environment, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 4-6 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 400 begins at operation 405, where the speech recognition application 30, executing on the server 70, receives the utterance 38 from the computing device 2. For example, a user of the computing device 2 may deliver the utterance 38 into a microphone of the computing device 2, for delivery to the server 70, in order to initiate a search query. The utterance may include distorted speech caused by a noisy environment (such as a subway station) and channel distortion.

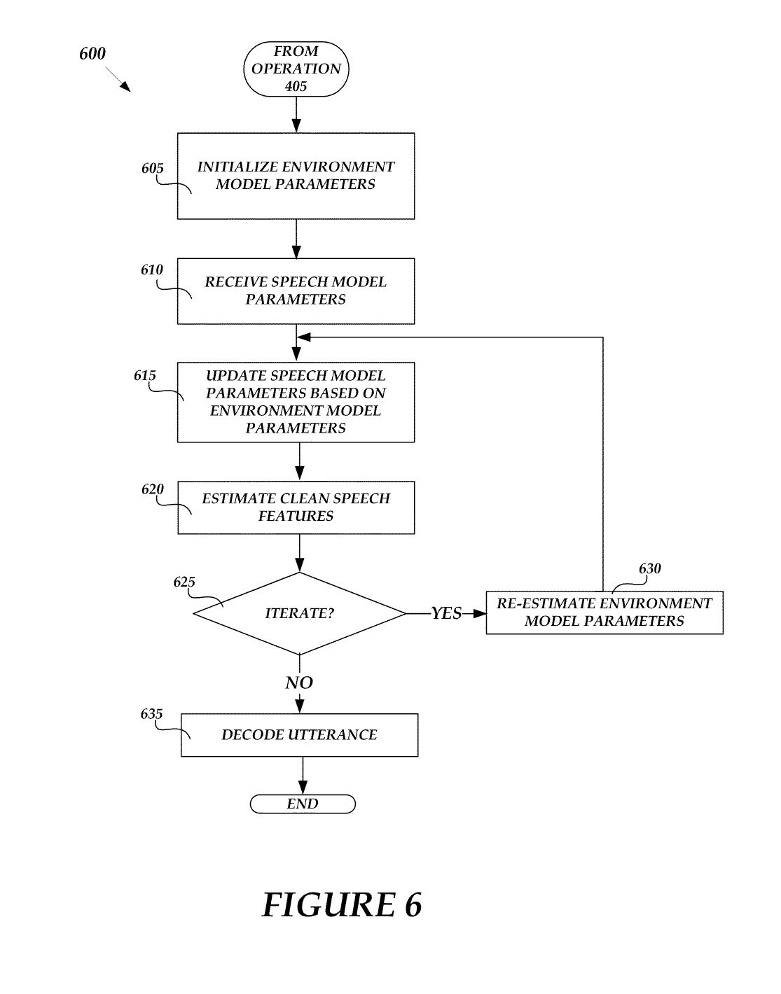

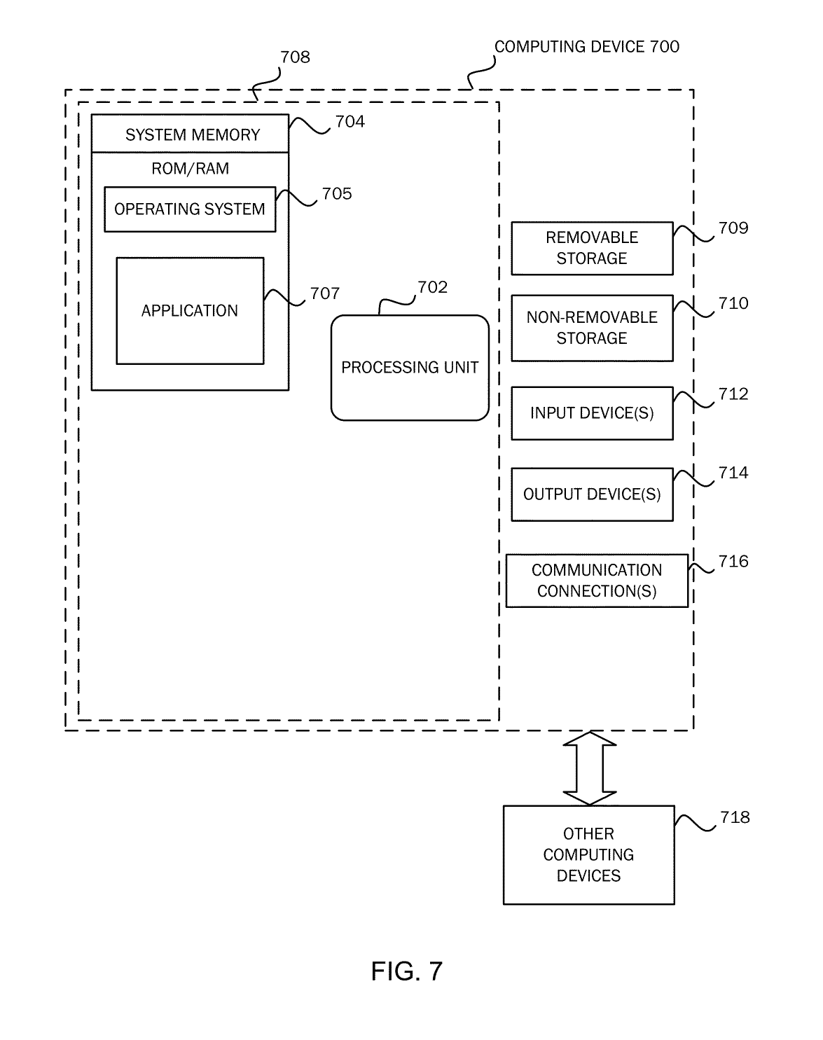

From operation 405, the routine 400 continues to operation 410, where the speech recognition application 30, executing on the server 70, may execute an algorithm (i.e., perform computations) using scalar operations for recognizing the utterance. As will be discussed in greater detail below with respect to FIGS. 5-6, the algorithm executed by the speech recognition application 30 may be applied to either model adaptation or speech feature enhancement. For model adaptation, the algorithm may utilize HMM parameters and for speech feature enhancement, the algorithm may utilize GMM parameters. In accordance with another embodiment, the speech recognition application 30 may utilize a VTS with Jacobian approximation algorithm, as will be discussed in greater detail below. It should be understood however, that other distortion-model-based algorithms in addition to those discussed above, may also be utilized in accordance with the various embodiments described herein. From operation 410, the routine 400 then ends.

FIG. 5 is a flow diagram illustrating a routine 500 for utilizing a speech recognition application to execute an algorithm with scalar operations for speech adaptation, in accordance with various embodiments. The routine 500 which follows the operation 405 of FIG. 4, begins at operation 505, where the speech recognition application 30, executing on the server 70, initializes the environmental distortion parameters 35 (i.e., the noise mean parameter 50, the channel mean parameter 52 and the noise variance parameter 54).

From operation 505, the routine 500 continues to operation 510, where the speech recognition application 30, executing on the server 70 receives the speech model parameters 40.

From operation 510, the routine 500 continues to operation 515, where the speech recognition application 30, executing on the server 70, updates the speech model parameters 40 based on the environmental distortion parameters 35. In particular, the initialized parameters 50, 52 and 54 may be updated in a scalar format in which a mathematical function utilizes only single numbers for performing computations. The aforementioned mathematical function and computations will be described in greater detail below.

From operation 515, the routine 500 continues to operation 520, where the speech recognition application 30, executing on the server 70, decodes the utterance 38 containing the distorted speech, based on the updated speech model parameters.

From operation 520, the routine 500 continues to operation 525, where the speech recognition application 30, executing on the server 70, determines whether the environmental distortion parameters 35 need to be re-estimated. If so, then the routine 500 continues to operation 530. If not, then the routine 500 then ends.

At operation 530, the speech recognition application 30, executing on the server 70, re-estimates the environmental distortion parameters 35. The routine 500 then returns to operation 515 for further updating of the speech model parameters 40. An algorithm detailing the re-estimation of the aforementioned parameters will be described in greater detail below.

FIG. 6 is a flow diagram illustrating a routine 600 for utilizing a speech recognition application to execute an algorithm with scalar operations for speech feature enhancement, in accordance with various embodiments. The routine 600 which follows the operation 405 of FIG. 4, begins at operation 605, where the speech recognition application 30, executing on the server 70, initializes the environmental distortion parameters 35 (i.e., the noise mean parameter 50, the channel mean parameter 52 and the noise variance parameter 54).

From operation 605, the routine 600 continues to operation 610, where the speech recognition application 30, executing on the server 70 receives the speech model parameters 40.

From operation 610, the routine 600 continues to operation 615, where the speech recognition application 30, executing on the server 70, updates the speech model parameters 40 based on the environmental distortion parameters 35. In particular, the initialized parameters 50, 52 and 54 may be updated in a scalar format in which a mathematical function utilizes only single numbers for performing computations. The aforementioned mathematical function and computations will be described in greater detail below.

From operation 615, the routine 600 continues to operation 620, where the speech recognition application 30, executing on the server 70, estimates clean speech features from the updated speech model parameters.

From operation 620, the routine 600 continues to operation 625, where the speech recognition application 30, executing on the server 70, determines whether the environmental distortion parameters 35 need to be re-estimated. If so, then the routine 600 continues to operation 630. If not, then the routine 600 branches to operation 635.

At operation 630, the speech recognition application 30, executing on the server 70, re-estimates the environmental distortion parameters 35. The routine 600 then returns to operation 615 for further updating of the speech model parameters 40. An algorithm detailing the re-estimation of the aforementioned parameters will be described in greater detail below.

At operation 635, the speech recognition application 30, executing on the server 70, decodes the utterance 38 containing the distorted speech, based on the updated speech model parameters and the estimated clean speech features. From operation 635, the routine 600 then ends.

As discussed above with respect to FIGS. 5 and 6, the environmental distortion model 35 may utilize HMM with scalar operations for speech adaptation and GMM with scalar operations for speech feature enhancement. It should be understood that a model for environmental distortion may be represented by the following function:

y=x+h+Clog(1+exp(C⁻¹(n×h)))

In the above function, “y” is a parameter that represents distorted speech in a cepstral domain. As should be understood by those skilled in the art, a cepstral domain refers to a Fourier transform or discrete cosine transform of the logarithm of a power spectrum or magnitude spectrum. Further with respect to the above function, “x” represents a clean speech parameter, “n” represents a noise parameter, “h” represents a channel parameter and C is a discrete cosine transform (“DCT”). An illustrative distortion model-based algorithm with scalar operations utilizing HMM follows below:

μ_{y,d}(j,k)=f₁(μ_{x,d}(j,k),μ_{n,d},μ_{h,d}),

σ_{y,d}²(j,k)=f₂(σ_{x,d}²(j,k),σ_{n,d}²)

μ_{Δy,d}(j,k)=f₃(μ_{Δx,d}(j,k),μ_{Δn,d},μ_{μΔh,d})

μ_{ΔΔy,d}(j,k)=f₄(μ_{ΔΔx,d}(j,k),μ_{ΔΔn,d},μ_{μΔΔh,d})

σ_{Δy,d}²(j,k)=f₅(σ_{Δx,d}²(j,k),σ_{Δn,d}²)

σ_{ΔΔy,d}(j,k)=f₆(σ_{ΔΔx,d}²(j,k),σ_{ΔΔn,d}²)

With respect to the above functions, μ_{y}, μₓ, μₙ, and μₕ are the static cepstral means of distorted speech, clean speech, noise, channel, respectively. Δ denotes the delta parameter and ΔΔ denotes the delta-delta parameter. The distortion-model-based algorithm with scalar operations can be applied to either model adaptation (i.e., HMM) or feature enhancement (GMM). In the above functions, d=[1, D], where D is the dimension of a static cepstrum. The (j, k) element in HMM means the k-th Gaussian in the j-th state. Since GMM may be represented as a single state HMM, the (j, k) element in the above functions may be represented as (k).

The following functions illustrate parameter re-estimation with scalar operations:

μ_{n,d}=g₁(μ_{x,d}(j,k),μ_{y,d}(j,k),μ_{n,d,0},μ_{h,d,0})

μ_{h,d}=g₂(μ_{x,d}(j,k),μ_{y,d}(j,k),μ_{n,d,0},μ_{h,d,0})

σ_{n,d}²=g₃(σ_{x,d}²(j,k),σ_{y,d}²(j,k),σ_{n,d,0}²)

With respect to the above functions, μ_{n,d,0}, μ_{h,d,0}, σ_{n,d,0}² are the initial values for static noise mean, static channel mean, and static noise variance, respectively. It should be understood that dynamic distortion parameters may also be re-estimated in a similar way. The f and g functions shown above are general functions for the distortion model-based algorithm. It should be appreciated that the functions discussed above may be used as formulations of HMM model adaptation. However, it should be understood, by those skilled in the art, that the functions may also be utilized to update a GMM model for feature enhancement (discussed above with respect to FIG. 5). It should be understood that clean speech can be estimated with either of the following functions in which p(k|y) represents the Gaussian occupancy probability and \hat{x}_{MMSE} represents cleaned speech (i.e., the clean speech feature discussed above with respect to operation 525 of FIG. 5):

$${\hat{x}}_{MMSE} = y - h - {\sum }_{k = 1}^{K} p ( k \vert y ) Clog ( 1 + exp ( {C}^{- 1} ( {μ}_{n} - {μ}_{x , k} - {μ}_{h} ) ) )$$

$${\hat{x}}_{MMSE} = {\sum }_{k = 1}^{K} p ( k \vert y ) ( {μ}_{x , k} + {\sum }_{x , k} {{G}_{k}^{T} ( {\sum }_{y , k} )}^{- 1} ( y - {μ}_{y , k} ) )$$

As briefly discussed above, a VTS with diagonal Jacobian approximation algorithm may be utilized as a special case of the environmental distortion model 35. It should be understood that the aforementioned algorithm may be used in either model adaptation or feature enhancement applications. An illustrative distortion model-based algorithm with scalar operations utilizing VTS with diagonal Jacobian approximation follows below:

$$G ( j , k ) = C diag ( \frac{1}{1 + exp ( {C}^{- 1} ( {μ}_{n} - {μ}_{x} ( j , k ) - {μ}_{h} ) )} ) {C}^{T}$$

The above function is a Gaussian-dependent Jacobian transform for the k-th Gaussian in the j-th state. As should be understood by those skilled in the art, the above function may be represented diagonally as:

G(j,k)=diag([G₁₁(j,k),G₂₂(j,k), . . . G_{DD}(j,k)])

The distortion model may then be represented as:

μ_{y}=μₓ+μₕ+Clog(1+exp(C⁻¹(μₙ−μₓ−μₕ)))

The following functions correspond to scalar operations for updating distortion model parameters in a dimension-by-dimension style:

σ_{y,d}²(j,k)=G_{dd}²(j,k)σ_{n,d}²(j,k)+(1.0−G_{dd}²(j,k))²σ_{n,d}²

μ_{Δy,d}(j,k)=G_{dd}(j,k)μ_{Δx,d}(j,k)

μ_{ΔΔy,d}(j,k)=G_{dd}(j,k),μ_{ΔΔx,d}(j,k)

σ_{Δy,d}²(j,k)=G_{dd}²(j,k)σ_{Δx,d}²(j,k)+(1.0−G_{dd}(j,k))²σ_{n,d}²

σ_{ΔΔy,d}(j,k)=G_{dd}²(j,k)σ_{ΔΔx,d}²(j,k)+(1.0−G_{dd}(j,k))²σ_{n,d}²

The following functions correspond to the re-estimation of distortion parameters with scalar operations. For example, the re-estimation of μ_{n,d} may be determined by:

μ_{n,d}=μ_{n,d,0}+a_{d}/b_{d}a_{d}=Σ_{t,j,k}γₜ(j,k)(1.0−G_{dd}(j,k))(y_{t,d}−μ_{x,d}(j,k)−μ_{h,d,0}−g_{d}(μₓ(j,k),μ_{h,0},μ_{n,0}))/σ_{y,d}²(j,k)b_{d}=Σ_{t,j,k}γₜ(j,k)(1.0−G_{dd}(j,k)²/σ_{y,d}²(j,k)

Similarly, the re-estimation of μ_{h,d} may be determined by:

μ_{h,d}=μ_{h,d,0}+c_{d}/e_{d}c_{d}=Σ_{t,j,k}γₜ(j,k)G_{dd}(j,k))(y_{t,d}−μ_{x,d}(j,k)−μ_{h,d,0}−g_{d}(μₓ(j,k),μ_{h,0},μ_{n,0}))/σ_{y,d}²(j,k)e_{d}=Σ_{t,j,k}γₜ(j,k)G_{dd}(j,k)²/σ_{y,d}²(j,k)

The following functions describe the estimation of a noise variance parameter or vector (such as the noise variance parameter 54). To estimate the D-dimension static noise variance vector Σₙ=diag(σₙ²) with σₙ²=[(σ_{n,1}², σ_{n,2}² . . . σ_{n,D}²]^{T}, the function \tilde{σ}ₙ²=log σₙ² is updated as follows:

$${\tilde{σ}}_{n , d}^{2} = {\tilde{σ}}_{n , d , 0}^{2} - \frac{\partial Q}{\partial {\tilde{σ}}_{n , d}^{2}} / \frac{{\partial }^{2} Q}{{\partial }^{2} {\tilde{σ}}_{n , d}^{2}}$$

$${Γ}_{d} ( j , k ) = {σ}_{x , i}^{2} ( j , k ) {G}_{dd}^{2} ( j , k ) + {{σ}_{n , d}^{2} ( 1.0 - {G}_{dd} ( j , k ) )}^{2}$$

$$\frac{\partial Q}{\partial {\tilde{σ}}_{n , d}^{2}} = - \frac{1}{2} {\sum }_{t , j , k} {γ}_{t} ( j , k ) \frac{{{σ}_{n , d}^{2} ( 1.0 - {G}_{dd} ( j , k ) )}^{2}}{{Γ}_{d} ( j , k )} ( 1 - \frac{{( {y}_{t , d} - {μ}_{y , d} ( j , k ) )}^{2}}{{Γ}_{d} ( j , k )} )$$

$$\frac{{\partial }^{2} Q}{{\partial }^{2} {\tilde{σ}}_{n , d}^{2}} = - \frac{1}{2} {\sum }_{t , j , k} {γ}_{t} ( j , k ) ( \frac{{{σ}_{n , d}^{2} ( 1.0 - {G}_{dd} ( j , k ) )}^{2}}{{Γ}_{d} ( j , k )} ( 1 - \frac{{( {y}_{t , d} - {μ}_{y , d} ( j , k ) )}^{2}}{{Γ}_{d} ( j , k )} ) + \frac{{( {{σ}_{n , d}^{2} ( 1.0 - {G}_{dd} ( j , k ) )}^{2} )}^{2}}{{Γ}_{d}^{2} ( j , k )} ( - 1 + 2 \frac{{( {y}_{t , d} - {μ}_{y , d} ( j , k ) )}^{2}}{{Γ}_{d , jk}} ) )$$

With respect to the above functions, Q is an auxiliary function and γₜ(j, k) is the posterior probability of the k-th Gaussian in the j-th state at time t. The static noise variance in the linear scale may be obtained with σₙ²=exp(\tilde{σ}ₙ²). It should be understood that both the delta and the delta-delta noise variances may be estimated in a similar way.

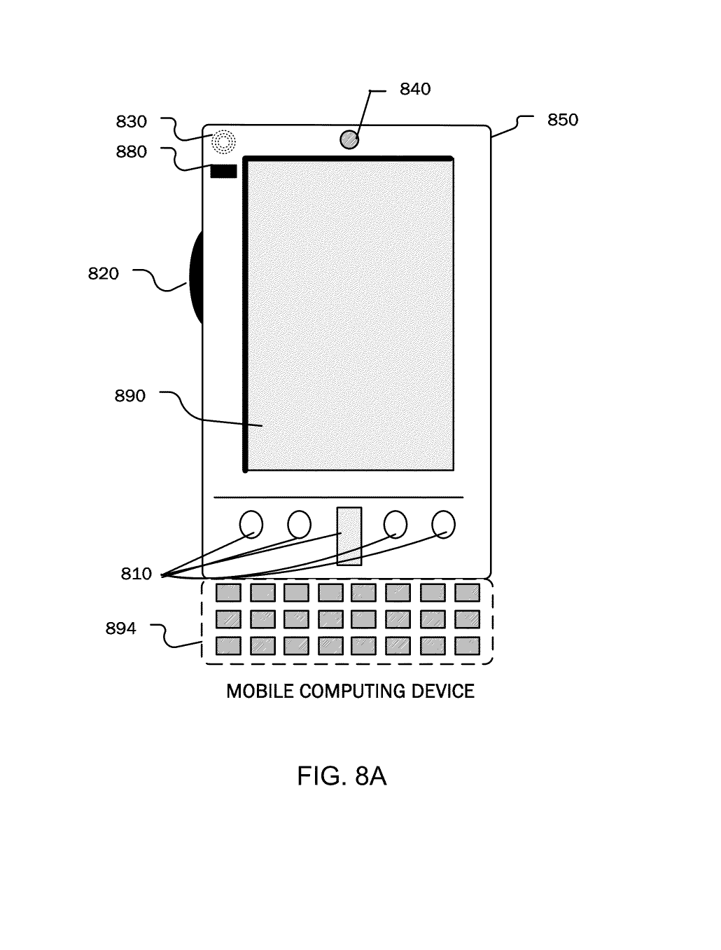

FIG. 7 is a block diagram illustrating example physical components of a computing device 700 with which various embodiments may be practiced. In a basic configuration, the computing device 700 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include an operating system 705 and application 707. Operating system 705, for example, may be suitable for controlling computing device 700's operation and, in accordance with an embodiment, may comprise the WINDOWS operating systems from MICROSOFT CORPORATION of Redmond, Wash. The application 707, for example, may comprise the functionality for receiving an utterance and transmitting the utterance to the server 70 for speech recognition. It should be understood, however, that the embodiments described herein may also be practiced in conjunction with other operating systems and application programs and further, is not limited to any particular application or system.

The computing device 700 may have additional features or functionality. For example, the computing device 700 may also include additional data storage devices (removable and/or non-removable) such as, for example, magnetic disks, optical disks, solid state storage devices (“SSD”), flash memory or tape. Such additional storage is illustrated in FIG. 7 by a removable storage 709 and a non-removable storage 710. The computing device 700 may also have input device(s) 712 such as a keyboard, a mouse, a pen, a sound input device (e.g., a microphone) for receiving a voice input, a touch input device for receiving gestures, etc. Output device(s) 714 such as a display, speakers, a printer, etc. may also be included. The aforementioned devices are examples and others may be used.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, automotive computing systems and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 700 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The system memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 700. Any such computer storage media may be part of the computing device 700.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

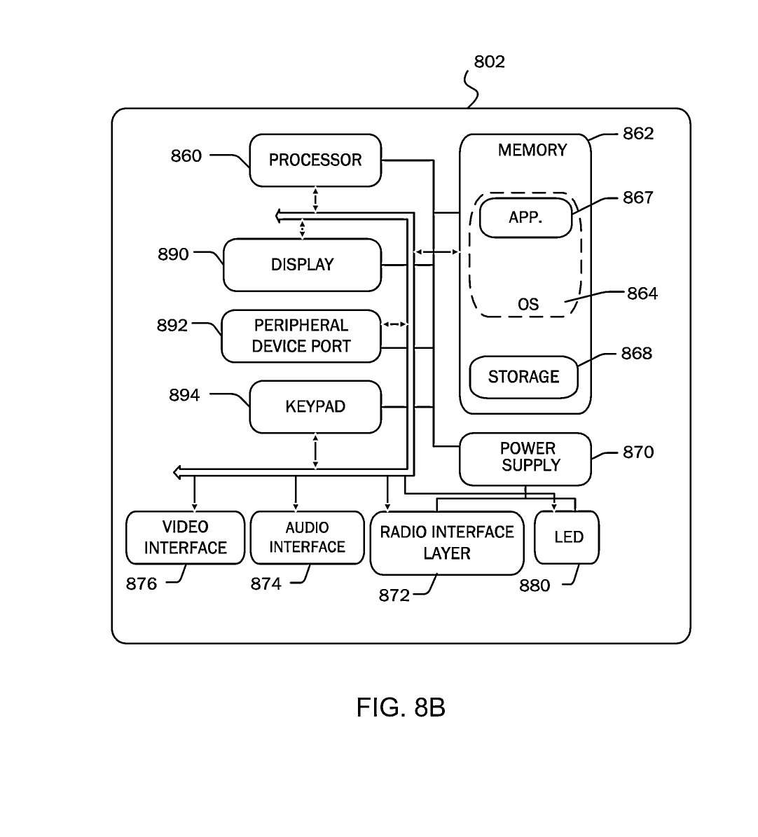

FIGS. 8A and 8B illustrate a suitable mobile computing environment, for example, a mobile computing device 850 which may include, without limitation, a smartphone, a tablet personal computer, a laptop computer, and the like, with which various embodiments may be practiced. With reference to FIG. 8A, an example mobile computing device 850 for implementing the embodiments is illustrated. In a basic configuration, mobile computing device 850 is a handheld computer having both input elements and output elements. Input elements may include touch screen display 825 and input buttons 810 that allow the user to enter information into mobile computing device 850. Mobile computing device 850 may also incorporate an optional side input element 820 allowing further user input. Optional side input element 820 may be a rotary switch, a button, or any other type of manual input element. In alternative embodiments, mobile computing device 850 may incorporate more or less input elements. For example, display 825 may not be a touch screen in some embodiments. In yet another alternative embodiment, the mobile computing device is a portable telephone system, such as a cellular phone having display 825 and input buttons 810. Mobile computing device 850 may also include an optional keypad 894. Optional keypad 894 may be a physical keypad or a “soft” keypad generated on the touch screen display.

Mobile computing device 850 incorporates output elements, such as display 890, which can display a graphical user interface (GUI). Other output elements include speaker 830 and LED light 880. Additionally, mobile computing device 850 may incorporate a vibration module (not shown), which causes mobile computing device 850 to vibrate to notify the user of an event. In yet another embodiment, mobile computing device 850 may incorporate a headphone jack (not shown) for providing another means of providing output signals.

Although described herein in combination with mobile computing device 850, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 8B is a block diagram illustrating components of a mobile computing device used in one embodiment, such as the mobile computing device 850 shown in FIG. 8A. That is, mobile computing device 850 can incorporate a system 802 to implement some embodiments. For example, system 802 can be used in implementing a “smart phone” or tablet computer that can run one or more applications similar to those of a desktop or notebook computer. In some embodiments, the system 802 is integrated as a computing device, such as an integrated personal digital assistant (PDA) and wireless phone.

Application 867 may be loaded into memory 862 and run on or in association with an operating system (“OS”) 864. The system 802 also includes non-volatile storage 868 within memory the 862. Non-volatile storage 868 may be used to store persistent information that should not be lost if system 802 is powered down. The application 867 may use and store information in the non-volatile storage 868. A synchronization application (not shown) also resides on system 802 and is programmed to interact with a corresponding synchronization application resident on a host computer to keep the information stored in the non-volatile storage 868 synchronized with corresponding information stored at the host computer. As should be appreciated, other applications may also be loaded into the memory 862 and run on the mobile computing device 850.

The system 802 has a power supply 870, which may be implemented as one or more batteries. The power supply 870 might further include an external power source, such as an AC adapter or a powered docking cradle that supplements or recharges the batteries.

The system 802 may also include a radio 872 (i.e., radio interface layer) that performs the function of transmitting and receiving radio frequency communications. The radio 872 facilitates wireless connectivity between the system 802 and the “outside world,” via a communications carrier or service provider. Transmissions to and from the radio 872 are conducted under control of OS 864. In other words, communications received by the radio 872 may be disseminated to the application 867 via OS 864, and vice versa.

The radio 872 allows the system 802 to communicate with other computing devices, such as over a network. The radio 872 is one example of communication media. The embodiment of the system 802 is shown with two types of notification output devices: LED 880 that can be used to provide visual notifications and an audio interface 874 that can be used with speaker 830 to provide audio notifications. These devices may be directly coupled to the power supply 870 so that when activated, they remain on for a duration dictated by the notification mechanism even though processor 860 and other components might shut down for conserving battery power. The LED 880 may be programmed to remain on indefinitely until the user takes action to indicate the powered-on status of the device. The audio interface 874 is used to provide audible signals to and receive audible signals from the user. For example, in addition to being coupled to speaker 830, the audio interface 874 may also be coupled to a microphone (not shown) to receive audible input, such as to facilitate a telephone conversation. In accordance with embodiments, the microphone may also serve as an audio sensor to facilitate control of notifications. The system 802 may further include a video interface 876 that enables an operation of on-board camera 840 (shown in FIG. 8A) to record still images, video streams, and the like.

A mobile computing device implementing the system 802 may have additional features or functionality. For example, the device may also include additional data storage devices (removable and/or non-removable) such as, magnetic disks, optical disks, or tape. Such additional storage is illustrated in FIG. 8B by storage 868.

Data/information generated or captured by the mobile computing device 850 and stored via the system 802 may be stored locally on the mobile computing device 850, as described above, or the data may be stored on any number of storage media that may be accessed by the device via the radio 872 or via a wired connection between the mobile computing device 850 and a separate computing device associated with the mobile computing device 850, for example, a server computer in a distributed computing network such as the Internet. As should be appreciated such data/information may be accessed via the mobile computing device 850 via the radio 872 or via a distributed computing network. Similarly, such data/information may be readily transferred between computing devices for storage and use according to well-known data/information transfer and storage means, including electronic mail and collaborative data/information sharing systems.

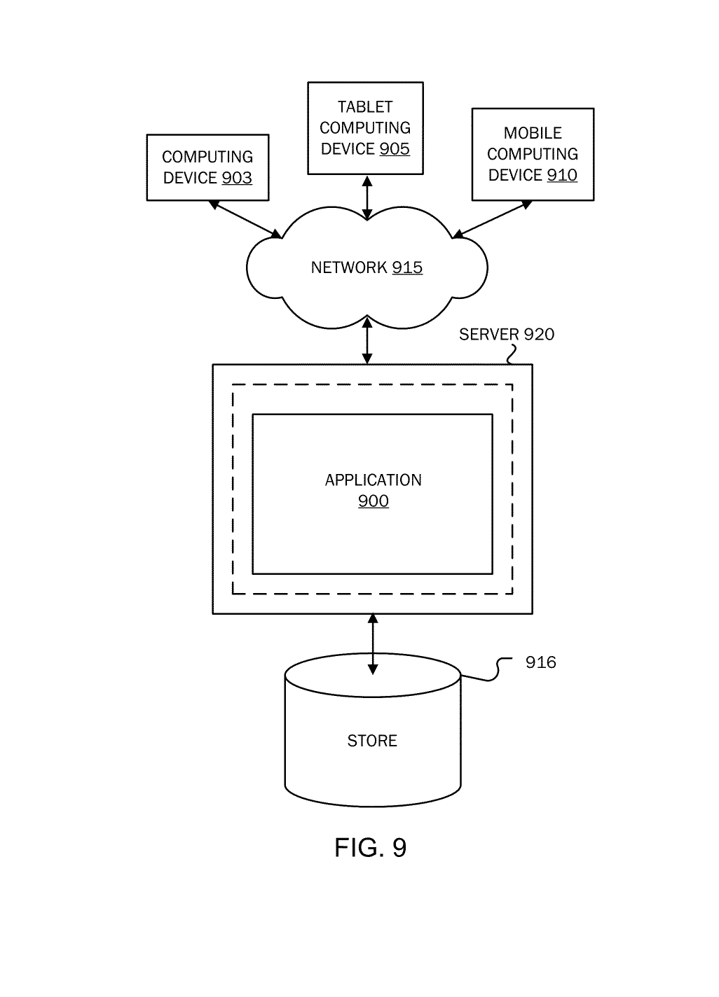

FIG. 9 is a simplified block diagram of a distributed computing system in which various embodiments may be practiced. The distributed computing system may include number of client devices such as a computing device 903, a tablet computing device 905 and a mobile computing device 910. The client devices 903, 905 and 910 may be in communication with a distributed computing network 915 (e.g., the Internet). A server 920 is in communication with the client devices 903, 905 and 910 over the network 915. The server 920 may store application 900 which may be perform routines including, for example, one or more of the operations in the routines 400, 500 and 600 described above.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routine's operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein.

What is claimed is:

1. A computer-implemented method of utilizing scalar operations for recognizing an utterance during automatic speech recognition in a noisy environment, comprising:
receiving, by the computer, the utterance, the utterance comprising distorted speech generated from a source through a transmission channel for delivery to a receiver, the distorted speech being caused by channel distortion and the noisy environment; and
performing, by the computer, a plurality of computations using the scalar operations for recognizing the utterance.

2. The method of claim 1, wherein performing, by the computer, a plurality of computations using the scalar operations for recognizing the utterance comprises performing the plurality of computations using the scalar operations for speech adaptation.

3. The method of claim 1, wherein performing, by the computer, a plurality of computations using the scalar operations for recognizing the utterance comprises performing the plurality of computations using the scalar operations for speech feature enhancement.

4. The method of claim 2, wherein performing the plurality of computations using the scalar operations for speech adaptation comprises:
initializing environmental distortion model parameters including noise mean, channel mean and noise variance parameters;
receiving speech model parameters;
updating the speech model parameters based on the initialized environmental distortion model parameters;
decoding the utterance;
determining whether the environmental distortion model parameters need to be re-estimated; and
re-estimating the environmental distortion model parameters upon determining that the environmental distortion model parameters need to be re-estimated.

5. The method of claim 3, wherein performing the plurality of computations using the scalar operations for speech feature enhancement comprises:
initializing environmental distortion model parameters including noise mean, channel mean and noise variance parameters;
receiving speech model parameters;
updating the speech model parameters based on the initialized environmental distortion model parameters;
estimating clean speech features;
determining whether the environmental distortion model parameters need to be re-estimated;
re-estimating the environmental distortion model parameters upon determining that the environmental distortion model parameters need to be re-estimated; and
decoding the utterance upon determining that the environmental distortion model parameters do not need to be re-estimated.

6. The method of claim 4, wherein updating the speech model parameters based on the initialized environmental distortion model parameters comprises updating the speech model parameters in a scalar format, the scalar format comprising a mathematical function utilizing only single numbers instead of matrices for performing the plurality of computations.

7. The method of claim 5, wherein updating the speech model parameters based on the initialized environmental distortion model parameters comprises updating the speech model parameters in a scalar format, the scalar format comprising a mathematical function utilizing only single numbers instead of matrices for performing the plurality of computations.

8. The method of claim 1, wherein performing, by the computer, a plurality of computations using the scalar operations for recognizing the utterance comprises utilizing a Vector Taylor Series with Jacobian approximation algorithm.

9. An apparatus for utilizing scalar operations in the recognition of distorted speech in a noisy environment, comprising:
a memory for storing executable program code; and
a processor, functionally coupled to the memory, the processor being responsive to computer-executable instructions contained in the program code and operative to:
receive an utterance comprising distorted speech generated from a source through a transmission channel for delivery to a receiver, the distorted speech being caused by channel distortion and the noisy environment; and
perform a plurality of computations using the scalar operations for recognizing the utterance.

10. The apparatus of claim 9, wherein the processor, in performing a plurality of computations using the scalar operations for recognizing the utterance, is operative to perform the plurality of computations using the scalar operations for speech adaptation.

11. The apparatus of claim 9, wherein the processor, in performing a plurality of computations using the scalar operations for recognizing the utterance, is operative to perform the plurality of computations using the scalar operations for speech feature enhancement.

12. The apparatus of claim 10, wherein the processor, in performing the plurality of computations using the scalar operations for speech adaptation, is operative to:
initialize environmental distortion model parameters including noise mean, channel mean and noise variance parameters;
receive speech model parameters;
update the speech model parameters based on the initialized environmental distortion model parameters;
decode the utterance;
determine whether the environmental distortion model parameters need to be re-estimated; and
re-estimate the environmental distortion model parameters upon determining that the environmental distortion model parameters need to be re-estimated.

13. The apparatus of claim 11, wherein the processor, in performing the plurality of computations using the scalar operations for speech adaptation, is operative to:
initialize environmental distortion model parameters including noise mean, channel mean and noise variance parameters;
receive speech model parameters;
update the speech model parameters based on the initialized environmental distortion model parameters;
estimate clean speech features;
determine whether the environmental distortion model parameters need to be re-estimated;
re-estimate the environmental distortion model parameters upon determining that the environmental distortion model parameters need to be re-estimated; and
decode the utterance upon determining that the environmental distortion model parameters do not need to be re-estimated.

14. The apparatus of claim 12, wherein the processor, in updating the speech model parameters based on the initialized environmental distortion model parameters, is operative to update the speech model parameters in a scalar format, the scalar format comprising a mathematical function utilizing only single numbers instead of matrices for performing the plurality of computations.

15. The apparatus of claim 13, wherein the processor, in updating the speech model parameters based on the initialized environmental distortion model parameters, is operative to update the speech model parameters in a scalar format, the scalar format comprising a mathematical function utilizing only single numbers instead of matrices for performing the plurality of computations.

16. The apparatus of claim 9, wherein the processor, in performing a plurality of computations using the scalar operations for recognizing the utterance, is operative to utilize a Vector Taylor Series with Jacobian approximation algorithm.

17. A computer-readable storage medium comprising computer executable instructions which, when executed on a computer, will cause the computer to perform a method of utilizing scalar operations for recognizing an utterance during automatic speech recognition in a noisy environment, the method comprising:
receiving, by the computer, the utterance, the utterance comprising distorted speech generated from a source through a transmission channel for delivery to a receiver, the distorted speech being caused by channel distortion and the noisy environment; and
performing, by the computer, a plurality of computations using the scalar operations for recognizing the utterance, wherein the plurality of computations are performed for at least one of speech adaptation and speech feature enhancement.

18. The computer-readable storage medium of claim 17, wherein performing the plurality of computations using the scalar operations for speech adaptation comprises:
initializing environmental distortion model parameters including noise mean, channel mean and noise variance parameters;
receiving speech model parameters;
updating the speech model parameters based on the initialized environmental distortion model parameters, wherein updating the speech model parameters based on the initialized environmental distortion model parameters comprises updating the speech model parameters in a scalar format, the scalar format comprising a mathematical function utilizing only single numbers instead of matrices for performing the plurality of computations;
decoding the utterance;
determining whether the environmental distortion model parameters need to be re-estimated; and
re-estimating the environmental distortion model parameters upon determining that the environmental distortion model parameters need to be re-estimated.

19. The computer-readable storage medium of claim 17, wherein performing the plurality of computations using the scalar operations for speech feature enhancement comprises:
initializing environmental distortion model parameters including noise mean, channel mean and noise variance parameters;
receiving speech model parameters;
updating the speech model parameters based on the initialized environmental distortion model parameters, wherein updating the speech model parameters based on the initialized environmental distortion model parameters comprises updating the speech model parameters in a scalar format, the scalar format comprising a mathematical function utilizing only single numbers instead of matrices for performing the plurality of computations;
estimating clean speech features;
determining whether the environmental distortion model parameters need to be re-estimated;
re-estimating the environmental distortion model parameters upon determining that the environmental distortion model parameters need to be re-estimated; and
decoding the utterance upon determining that the environmental distortion model parameters do not need to be re-estimated.

20. The computer-readable storage medium of claim 17, wherein performing a plurality of computations using the scalar operations for recognizing the utterance comprises utilizing a Vector Taylor Series with Jacobian approximation algorithm.
